(19) United States
(12) Patent Application Publication
(10) Pub. No.: US 2007/0133120 A1
(43) Pub. Date: Jun. 14, 2007

(54) Magnetic storage device and method of correcting magnetic head position

(75) Inventor: Koji Ishii, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/385,125

(22) Filed: Mar. 21, 2006

(30) Foreign Application Priority Data
Dec. 13, 2005 (JP) 2005-359217

(51) Int. Cl. G11B 5/596

(52) U.S. Cl. 360/77.04

(57) ABSTRACT

A head position is corrected based on track deviation information read from a storage unit that stores the information on track deviation due to an abnormal pitch of a servo track. At the time of writing data, a track on which a read head R is to be positioned, which is determined based on correction of core deviation of a write head, is further corrected based on correction of track deviation information.

### BACKGROUND OF THE INVENTION

1. Field of the Invention

The present invention relates to a magnetic storage device and, more particularly, to a magnetic storage device that corrects track-pitch deviation.

2. Description of the Related Art

In general, a magnetic storage device or a magnetic disc device uses a write head to record data or information into a magnetic disc as a storage medium, and uses a read head to reproduce the recorded data or information. In recent years, most magnetic storage devices have a write head and a read head combined each other, instead of using one head to read and write data. When the writes head writes data on a disc, a read head is used to read position information or servo information, which is written in advance in a magnetic disc as a servo pattern. Based on the read servo information, the write head is positioned on a predetermined track, and writes data on the track, thereby preventing data from being written on adjacent tracks.

Therefore, a servo pattern must be written at a constant feeding pitch or at a constant track pitch so as to correctly indicate a track position. However, at the time of writing a servo pattern into a disc, a track can have an uneven track pitch in some cases. This track-pitch deviation occurs when a voice coil motor that moves the write head to write the servo pattern does not rotate satisfactorily, or when a push pin that moves the head to be used by a servo track writer is contacted unsatisfactorily, or when an environmental oscillation or shock occurs. This track-pitch deviation similarly occurs at the time of writing a servo pattern on a magnetic disc after the magnetic disc is assembled into a magnetic disc device, or at the time of writing a servo pattern on a magnetic disc before the magnetic disc is assembled into a magnetic disc device.

A track of which track width has become too small cannot be used. This influence spreads to other tracks when a read head and a write head are provided separately. In other words, conventionally, a track on which a read head is positioned is determined so that the write head is positioned on a predetermined track even if a yaw angle changes, by correcting a deflection angle of an arm on which the head is mounted, that is, by correcting a core deviation that occurs due to a yaw angle (see Japanese Patent Application Unexamined Publication No. 2000-322848). However, when the yaw angle changes, the number of tracks between the read head and the write head changes. In addition, a number of tracks between the read head and the write head changes due to an uneven track pitch. Therefore, when a track having a small or large track width is present among tracks between the read head and the write head, the write head cannot be accurately positioned on a predetermined track even if the core deviation is corrected.

Therefore, conventionally, not only a track of which the track pitch is abnormal but also a track on which the write head is not positioned even if core deviation is corrected are registered as faulty tracks. These tracks are not used.

### SUMMARY OF THE INVENTION

In the light of the above problems, it is an object of the present invention to provide a magnetic storage device and a method of correcting a magnetic head position capable of effectively using a wide range of faulty tracks even if a track pitch is abnormal.

In order to achieve the above object, according to one aspect of the present invention, there is provided a magnetic storage device including: a magnetic storage medium on which a servo track is formed; a head having a read head and a write head; a head moving unit that moves the head; and a storage unit that stores information of track deviation due to an abnormal pitch of the servo track, wherein a position of the head is corrected based on track deviation information that is read out from the storage unit.

According to another aspect of the invention, the storage unit can be a nonvolatile memory or a system region of the magnetic storage medium.

According to still another aspect of the invention, the track deviation information is stored in a table in which a track address, a track deviation, and a group number of a group of continuous track deviation are related to each other.

According to still another aspect of the invention, the correction of the head position includes correction of core deviation information based on the track deviation information.

According to still another aspect of the invention, there is provided a method, of correcting a magnetic head position, including storing information of track deviation due to an abnormal track pitch and correcting a position of a read head that should be positioned on the track using the stored track deviation information.

According to the present invention, as described above, the head position is corrected based on track deviation information read from a storage unit that stores the information of the track deviation due to an abnormal pitch of a servo track. Therefore, a medium surface can be used to effectively write data. A track on which data is written by correcting a head position does not interfere with adjacent tracks. Consequently, a highly reliable magnetic storage unit can be obtained.

### BRIEF DESCRIPTION OF THE DRAWINGS

FIG. 1 is an explanatory diagram of an outline of a magnetic storage device according to one embodiment of the present invention;

FIG. 2A is a schematic diagram of a magnetic head according to the present invention, and FIG. 2B is an explanatory diagram of the operation of the magnetic head;

FIG. 3 is an explanatory diagram showing one example of a test process of detecting track deviation which is to be corrected according to the present invention;

FIG. 4A is a core-deviation correction table, and FIG. 4B is an track-deviation correction table;

FIG. 5 is an explanatory diagram of the operation of correcting track deviation and writing data into the corrected track;

FIG. 6 is a flow diagram of the operation of data writing into a track 4;

FIG. 7 is a flow diagram of the operation of data reading from track 4;

FIG. 8 is a flow diagram of the operation of data writing into a track 7;

FIG. 9 is a flow diagram of the operation of data reading from track 7;

FIG. 10 is a flow diagram of the operation of data writing into a track 600;

FIG. 11 is a flow diagram of the operation of data reading from track 600;

FIG. 12 is a flow diagram of the operation of data writing into a track 700;

FIG. 13 is a flow diagram of the operation of data reading from track 700;

FIG. 14 is a flow diagram of the operation of data writing into a general track;

FIG. 15 is a flow diagram of the operation of data reading from the general track;

FIG. 16 is an explanatory diagram of a start operation of a magnetic recording device having a memory that stores track-deviation correction table; and

FIG. 17 is an explanatory diagram of a start operation of a magnetic recording device having a system region of a medium that stores an track-deviation correction table.

100 Magnetic disc device

10 Disc enclosure

11 Hard disc

13 Direct current motor

15 Head

16 Arm

17 Voice coil motor

19 Head amplifier

20 Printed circuit board

21 Hard disc controller

22 Data buffer

23 Read channel

25 Micro control unit

27 Servo controller

28 Memory

30 Host computer

### DETAILED DESCRIPTIONS

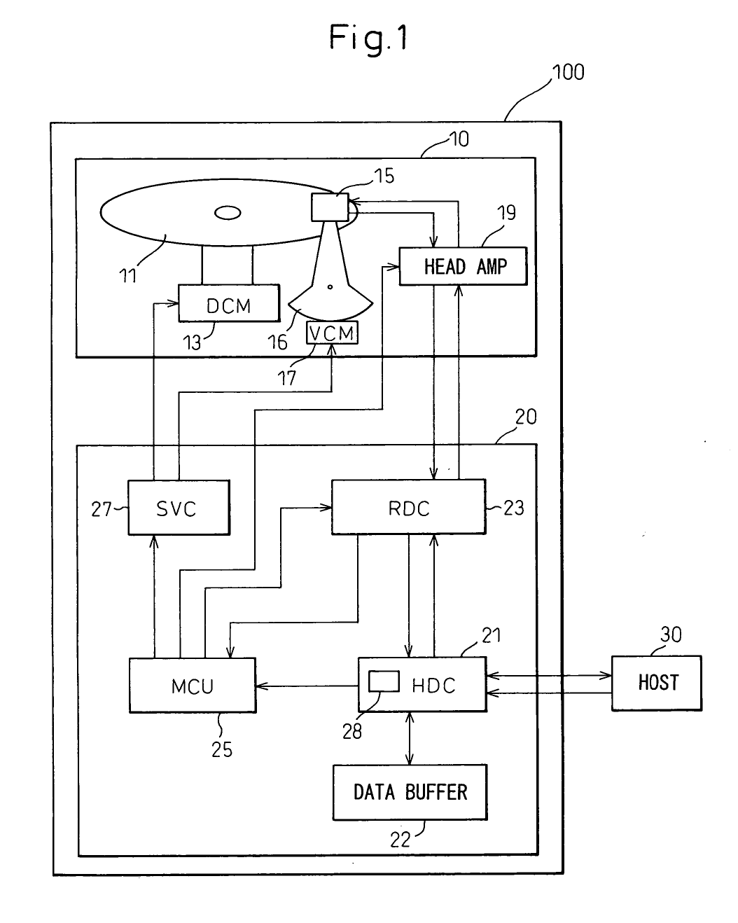

FIG. 1 shows a schematic configuration of one example of a magnetic disc device 100 according to one embodiment of the present invention. The magnetic disc device 100 has a disc enclosure 10 and a printed circuit board 20. The disc enclosure 10 includes a hard disc 11 as a magnetic recording medium, a direct current motor (DCM) 13 that rotates the hard disc 11, a head 15 that reads data from and writes data on the hard disc 11, an arm 16 that supports the head 15, a voice coil motor 17 that turns the arm 16 to move the head 15 in a radial direction of the hard disc 11, and a head amplifier 19 that amplifies a read signal read by the head 15 and amplifies a write signal written by the head 15. The disc enclosure 10 has a hole with a filter between the disc enclosure 10 and the outside, in order to protects the medium 11 and the head 15 from dust.

On the printed circuit board 20, there are disposed a servo controller 27 that controls a current supplied to the direct current motor (DCM) 13 and the voice coil motor 17, a read channel (RDC) 23 that receives a read signal from the head amplifier 19 and transmits a write signal to the head amplifier 19, a hard disc controller 21 that processes data, a data buffer 22, and a micro control unit 25 that executes the control. The hard disc controller 21 transmits data to a host computer 30, receives instructions from the host computer 30, transmits a write signal to the read channel 23, and receives a read signal from the read channel 23. These signals are also stored in the data buffer 22. The micro control unit 25 obtains address information from the hard disc controller 21, obtains position information from the read channel 23, and controls the servo controller 27, the voice coil motor 17, and the read channel 23. The hard disc controller 21 is disposed with a memory 28 such as a ROM (Read Only Memory), a Flash ROM, and an EPROM (Erasable Programmable Read-Only Memory), according to need. These memories can be also disposed at the outside of the hard disc controller 21. The memory 28 can store a core-deviation correction table or an track-deviation correction table, as described below.

The present embodiment that corrects track deviation postulates that track-pitch deviation is detected and a size of track deviation is measured. Before explaining the embodiments of the present invention, one example of a magnetic disc device testing method for detecting track-pitch deviation and measuring a size of the track deviation is explained.

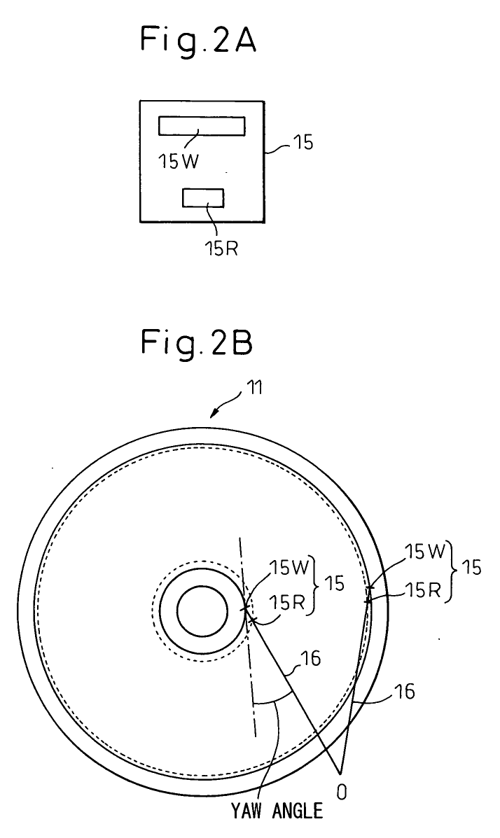

As shown in FIG. 2A, if the head 15, such as an MR (Magneto Resistive) head, a GMR (Giant Magneto Resistive) head, or a TuMR (Tunelling Magneto Resistive) head has a read head 15R and a write head 15W, a physical separation exists between the read head 15R and the write head 15W. This physical separation exists between heads that correspond to a horizontal magnetic recording or a vertical magnetic recording.

In order to change the on-track position of the head 15, usually, head position control using a rotary VCM (voice coil motor) is carried out. Specifically, as shown in FIG. 2B, the magnetic head 15 disposed at the front end of the arm 16 moves while describing an arc-shaped track in a radial direction of the magnetic disc 11, following the movement of the arm 16 that is driven by the voice coil motor. In FIG. 2B, 0 denotes a center of rotation of the magnetic head.

As shown in FIG. 2B, because a track is formed concentrically, a track that the read head 15R traces is different from a track that the write head 15W traces. In FIG. 2B, a solid line denotes a track on which the write head is positioned, and a dotted line denotes a track on which the read head is positioned. For example, when a distance between the read head 15R and the write head 15W is within a range of 5 μm to 10 μm, there are many tracks between the read head 15R and the write head 15W, because the track pitch is 0.2 μm to 0.3 μm. Further, due to the move of the arm, a yaw angle formed by a tangent line of tracks and the center line of the head changes. Therefore, the number of tracks between the read head 15R and the write head 15W changes, that is, the core deviation changes. Conventionally, the core deviation is controlled to be changed corresponding to the size of the yaw angle.

The magnetic disc device using such heads has further track deviation caused by an abnormal track pitch, if the track pitch becomes abnormal due to the track-pitch deviation at the time of writing a servo pattern.

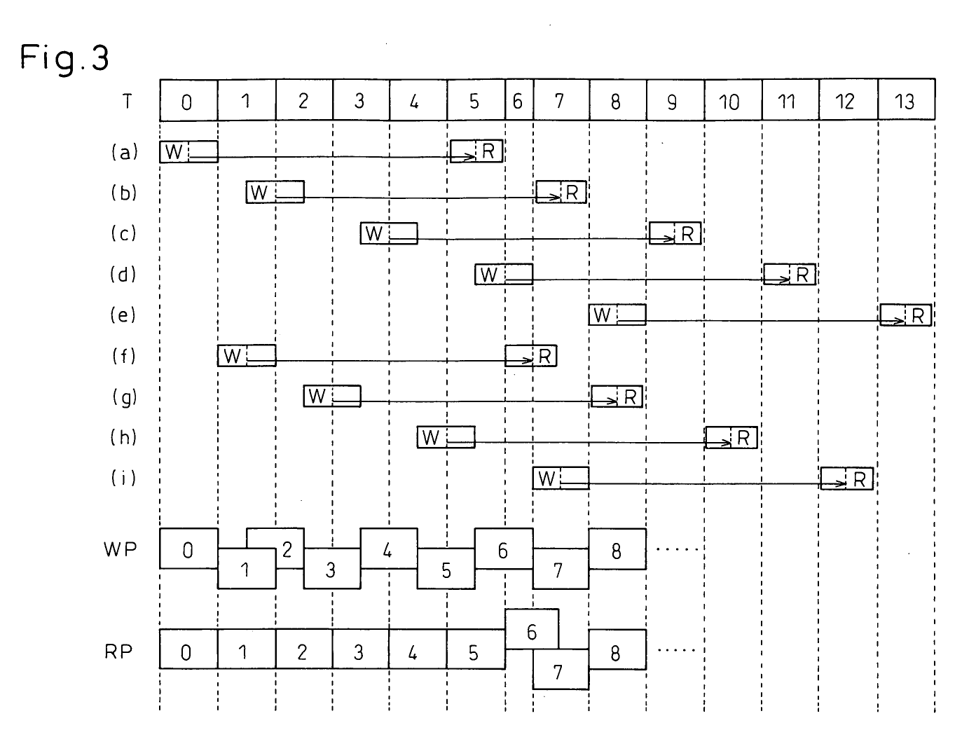

The test process for detecting track deviation is explained below with reference to FIG. 3. FIG. 3 schematically shows tracks of a disc in which a servo pattern is written. Numbers at the top of FIG. 3 are track numbers. Tracks 0 to 13 are shown in a vertical direction. A pitch of track 6 is smaller than a normal pitch. In FIG. 3, (a) to (i) denote a relationship between the write head W and the read head R during a data writing period. A line of an arrowhead that connects between the write head W and the read head R expresses a compensation for core deviation.

In FIG. 3, (a) to (e) show writing of data into even tracks 0, 2, 4, 6, and (f) to (i) show writing of data into odd tracks 1, 3, 5, 7. At a lower part of FIG. 3, a position at which the write head W writes data is expressed as a track write position WP. A position at which the read head R reads data is expressed as a track read position RP.

When the test process is started, predetermined different data are written into the even tracks 0, 2, 4, 6, etc., among tracks determined according to a servo pattern.

In the present example, there are five tracks that require correction of core deviation. Therefore, first in (a), at the time of writing data on track 0, the read head R is positioned on track 5. Next, in (b), data is written on track 2 by positioning the read head R on track 7. Next, in (c), data is written into track 4 by positioning the read head R on track 9. Thereafter, in (d) and (e), in order to position the write head W on a track in which data is to be written, the read head is positioned by considering the correction of the core deviation, which are five tracks and the data is written on predetermined tracks. In this way, data are written into all even tracks on the disc.

At the time of writing data into track 2 by positioning the read head R on track 7 in (b), the write head W is not accurately positioned on track 2, because track 6 has a narrow track pitch. Therefore, the write head W straddles the boundary between track 1 and track 2 to write data into these tracks. Similarly, at the time of writing data into track 4 in (c), the write head W straddles the boundary between track 3 and track 4 to write data on these tracks, because track 6 has a narrow track pitch. At the time of writing data into track 6 in (d), the write head W strides on track 5 and track 6 to write data on these tracks, because track 6 has a narrow track pitch. At the time of writing data on track 8 in (e), there is no abnormal track pitch between the write head W and the read head R. Therefore, when the read head R is positioned on track 13, data is accurately written into track 8.

After all the data are written on the even tracks starting from track 0 to the last even track, data are written on the odd tracks 1, 3, 5, etc.

When the read head R is positioned on track 6 in (f), data is written accurately on track 1. Although track 6 has a narrow pitch, the read head R can be positioned on track 6. At the time of writing data on track 3 by positioning the read head R on track 8 in (g), the write head is not accurately positioned on track 3, because track 6 has a narrow track pitch and the write head W straddles the boundary between track 2 and track 3 so as to write data into these tracks. Similarly, at the time of writing data into track 5 in (h), the write head W straddles the boundary between track 4 and track 5 to write data on these tracks, because track 6 having a narrow track pitch exists between the write head W and the read head R. At the time of writing data into track 7 in (i), the narrow track 6 is not between the write head W and the read head R. Therefore, when the read head R is positioned on track 12, data is accurately written into track 7. In this way, data are written into all odd tracks. A result of writing the data into all tracks is shown as the track write positions WP. As is shown in FIG. 3, the tracks WP2 to WP6 on which data are written straddle a boundary of adjacent tracks, without being accurately positioned on the tracks 2 to 6 defined by the correct servo pattern.

After the data are written on all tracks, these data are read out sequentially starting from track 0. A position of the read head R at the time of sequentially reading data starting from track 0 is expressed as the read position RP.

When the read head R is positioned on track 0, the data written in track 0 is accurately read. A part of the data to be written on track 2 is written on track 1 by the writing of the data on the even track. However data is overwritten by the writing into the odd track at the next step. Therefore, the data written in track 1 can be accurately read out when the read head R is positioned on track 1.

However, at the time of reading data from track 2, data written into track 2 and data written into track 3 are mixed in track 2 (see the write position WP). Therefore, an error rate becomes high, and the data cannot be accurately read out. Consequently, it is decided that track 2 has an error, and track 2 is registered as an error position.

Similarly, each of track 3 to track 6 has mixture of data in adjacent tracks, and read error occurs in these tracks. Data can be read accurately from track 8. As explained above, when a track pitch becomes narrow due to a write error of the servo pattern, a read error occurs not only in the track having a narrow track pitch but also in a track on which data is written when the narrow track exists between the write head W and the read head R. This error similarly occurs when a track has a wide track pitch.

Measurement of a size of abnormal track deviation is explained next. After a read error is checked for all tracks, a track in which a first error occurs is selected as a target track to be measured, and a position of the target track is measured. As measuring methods, there are a method of using an offset margin of a read head, and a method of using AGC (Automatic Gain Control) of a read signal.

According to the method of obtaining a track position using an offset margin of a read head, data around the track to be measured is erased first. Then, an offset margin is set so that the read head is positioned at one side with a distance from the track to be measured. The read head is gradually brought closer to the track while changing the offset margin, and it is decided whether data written in the track can be read. When the data can be read, an offset margin is set so that the read head is at the other side with a distance from the track to be measured, and a similar measurement is repeated. When an intermediate position at which the data of the track can be read is calculated, this becomes a position to be measured.

In other words, according to this measuring method, data is read at a predetermined position from both sides of the track while bringing the read head close to the track, and an error rate is measured, thereby finding a point at which the error rate reaches or exceeds a target value. There are two points at which the error rate reaches or exceeds the target value. Therefore, a center of the two points is a track position to be obtained.

According to the method of obtaining a target track position using an AGC gain of a read signal, data is written into only the target track to form a state that no data is present around this target track, in a similar manner to that of using the offset margin. Thereafter, a read head is positioned at the offset position with a distance from this track, the data is read, and a gain of the AGC circuit regarding the obtained read signal is read. At a position with a distance from the track, the gain of the AGC circuit takes a maximum value. At positions sequentially closer to the track, the AGC gain of the obtained read signal becomes smaller. At the on-track position, a signal output becomes a maximum, and therefore, the AGC gain becomes a minimum. A position of the target track can be obtained from a change in the AGC gain.

After measuring deviation of all error tracks, track numbers at which deviations are detected, their addresses and their deviations are stored in an track-deviation correction table. The track-deviation correction table can be also stored together with a table that stores core deviation.

As explained above, even if a deviation occurs in a track on which data is to be written, due to an uneven track pitch, this deviation can be obtained accurately. In the present embodiment, a track on which data is to be written is corrected, and a track from which data is to be read is corrected, based on the obtained deviation.

An embodiment according to the present invention are explained below with reference to the drawings.

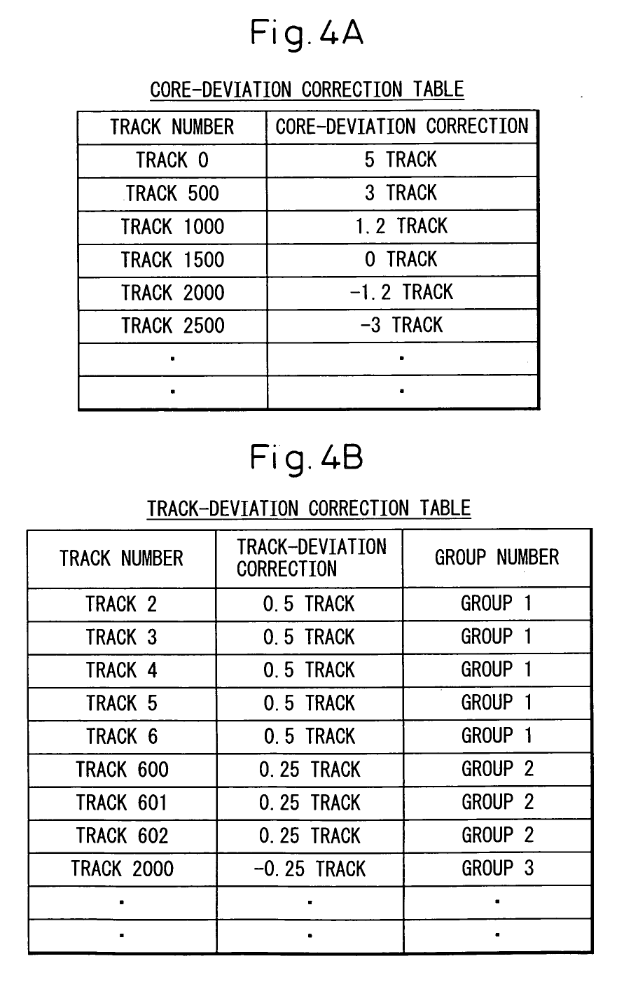

FIGS. 4A and 4B show examples of a core-deviation correction table and an track-deviation correction table that are used in an embodiment of the present invention. As shown in FIG. 4A, the core-deviation correction table is prepared by measuring a size of core deviation at every 500 tracks, for example. The correction of core deviation in tracks not registered in the table is obtained by linear interpolation. In FIG. 3, to simplify the explanation, the core-deviation correction value, i.e. five tracks to be corrected for track 0 are commonly applied to other tracks. However, strictly speaking, the track deviation needs to be calculated by linearly interpolating each track. Measuring a size of track deviation at every 500 tracks is merely one example, and the measuring method is not limited to this. It is needless to mention that a size of track deviation can be measured for all tracks.

As is seen from the example of the track-deviation correction table shown in FIG. 4B, continuous tracks of which deviations are the same are collected as one group, and the same group number is given to these tracks. In FIG. 4B, each of the tracks 2 to 6 has a deviation of 0.5 track, and therefore, these tracks belong to group 1.

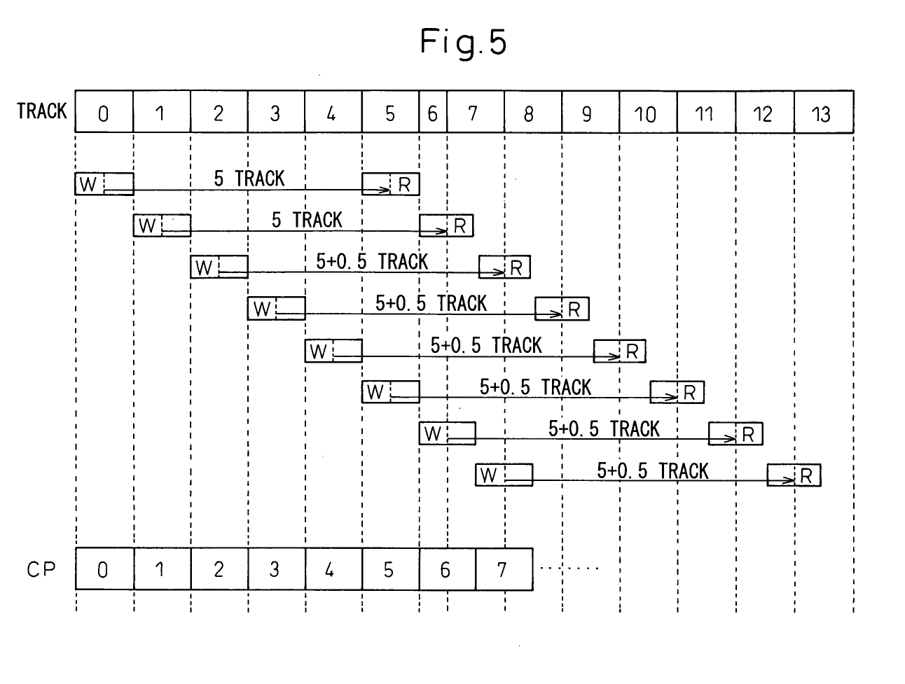

FIG. 5 schematically shows the outline according to an embodiment of the present invention. FIG. 5 shows a result of writing data on tracks after correcting track deviation according to the present invention. As seen in a track position CP after correction shown at a lower part of FIG. 5, tracks 0 to 6 have no track deviation, and data are written into predetermined positions, without interference with adjacent tracks. In other words, unlike mere correction of core deviation as shown in FIG. 3, data already written is not overwritten, even if data is written on odd tracks and data is written on even tracks afterward. Therefore, data can be read normally from track 2 to track 6 in which a read error occurs in the example shown in FIG. 3. In track 7 and subsequent tracks, data write position is deviated due to the abnormal track pitch in track 6. However, these tracks do not interfere with adjacent tracks. Therefore, the read head can read data accurately by only shifting the position of the read head by the equivalent amount.

The operation is explained in further detail with reference to FIG. 5. The correction tables shown in FIG. 4A and FIG. 4B are used. The correction of core deviation of track 0 is five tracks, and track 6 has a narrow track pitch of 0.5 track. Therefore, the correction of track deviation is 0.5 track. To simplify the explanation, in FIG. 5, the correction of core deviation is assumed to be five tracks for tracks other than track 0.

In writing data on track 0, the read head R is positioned on track 5, and the write head W is positioned on track 0, because the correction of core deviation is five tracks. Accordingly, data is written into track 0. Similarly, in writing data into track 1, the read head R is positioned on track 6, thereby positioning the write head W on track 1. Accordingly, data is written into track 1. Track 6 has a narrow track pitch, but the read head R can be positioned on this track.

Next, at the time of writing data into track 2, track 6 having a narrow track pitch is positioned between the write head W and the read head R. Therefore, a track deviation as well as the core deviation is corrected. Specifically, the position of the read head R is corrected to 5.5 tracks, which is a sum of the correction of core deviation five tracks and the correction of track deviation 0.5 track. In other words, in order to position the write head W on track 2, the read head R is conventionally positioned on track 7 which is the fifth track from track 2 in order to correct core deviation. On the other hand, according to the present embodiment, 0.5 track is further added to correct track deviation, thereby positioning the read head R on track 7.5. When the read head R is positioned on track 7.5, the write head W is positioned on track 2, thereby accurately writing data into track 2.

Thereafter, at the time of writing data into track 3 to track 6, track 6 having a narrow track pitch is positioned between the write head W and the read head R. Therefore, data is written into these tracks by correcting the position of the read head R based on the correction of core deviation and the correction of track deviation, in a similar manner to that of writing data on track 2.

Further, at the time of writing data on track 7 and subsequent tracks, data is written on these tracks by correcting the position of the read head R equivalent to the correction of core deviation plus the correction of track deviation, so as not to overwrite data into adjacent tracks.

As is shown by the corrected track position CP in FIG. 5, the position of the read head R does not require correction at the time of writing data on track 0 to track 6. However, at the time of writing data into track 7 and subsequent tracks, data needs to be written into these tracks by correcting the position of the read head R equivalent to the correction of track deviation by 0.5 track.

Data writing on and data reading from specific tracks according to the present embodiment are explained next.

### EXAMPLE 1

### Writing of Data Into Track 4

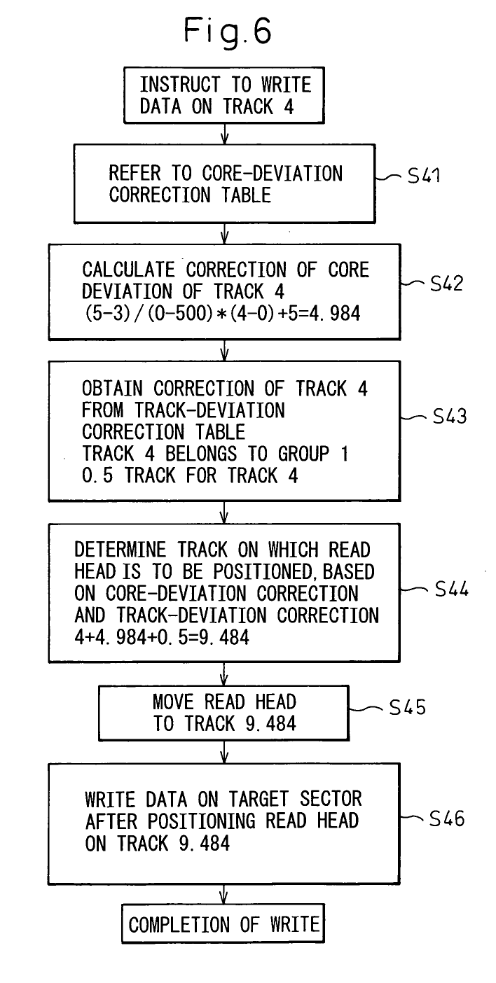

FIG. 6 shows an operation flow for writing data on track 4. When an instruction to write data on track 4 is given, the core-deviation correction table (FIG. 4A) is first referred to obtain the correction of core deviation of track 4 (step S41). The core-deviation correction table is stored in a nonvolatile memory such as a flash memory or a system region of a hard disc. Track 4 is not registered in the core-deviation correction table. Therefore, the correction of core deviation of track 4 is obtained by a linear interpolation (step S42).

In other words, track 4 is positioned between track 0 and track 500. The correction of core deviation of track 0 is five tracks, and the correction of core deviation of track 500 is three tracks. Therefore, the correction of core deviation of track 4 is obtained as follows.
[(5−3)/(0−500)]×(4−0)+5=4.984

Next, the correction of track deviation of track 4 is read from the track-deviation correction table (FIG. 4B) (step S43). Because track 4 belongs to the group 1, the deviation 0.5 track of the group 1 becomes the correction of track deviation of track 4. The core-deviation correction table can be stored in a nonvolatile memory such as a flash memory or a system region of a hard disc.

After the correction of core deviation and the correction of track deviation of track 4 on which the write head is to be positioned are obtained, a track on which the read head is to be positioned is determined based on the correction of core deviation and the correction of track deviation obtained above (step S44). Specifically, a track 9.484, which is given as a sum of track 4, the correction of core deviation 4.984 and the correction of track deviation 0.5, gives a position of the track on which the read head is to be positioned.

After the track on which the read head is to be positioned is determined, the read head is moved to track 9.484 on which the read head is to be positioned (step S45). After the read head is positioned on track 9.484, data is written on a sector of track 4 by the write head (step S46). Thus, the data can be accurately written on track 4.

### EXAMPLE 2

### Data Reading From Track 4

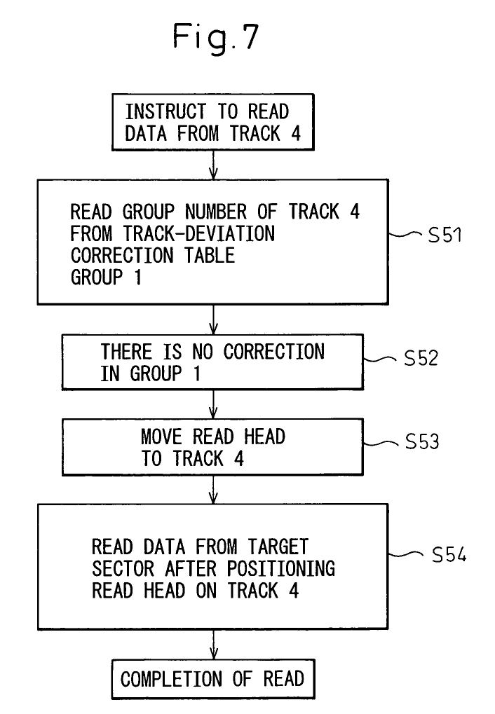

FIG. 7 shows an operation flow for reading data from track 4. Unlike the data write operation, the data read operation does not require correction of core deviation. Therefore, when a data read instruction is given, the track-deviation correction table is referred to. Then a group number corresponding to track 4 is read from the track-deviation correction table (FIG. 4B) (step S51). Track 4 corresponds to group 1.

Next, correction of track deviation is calculated, and a track on which the read head is to be positioned is calculated. In this case, track 4 belongs to the group 1 and there is clearly no group that requires correction of track deviation before the group 1. Therefore, the correction of track deviation is zero (step S52).

Consequently, the read head is moved to track 4, without requiring correction of track deviation (step S53), and data is read from a sector of the target track after the read head is positioned on track 4 (step S54). Thus, the data is read from track 4.

### EXAMPLE 3

### Data Writing Into Track 7

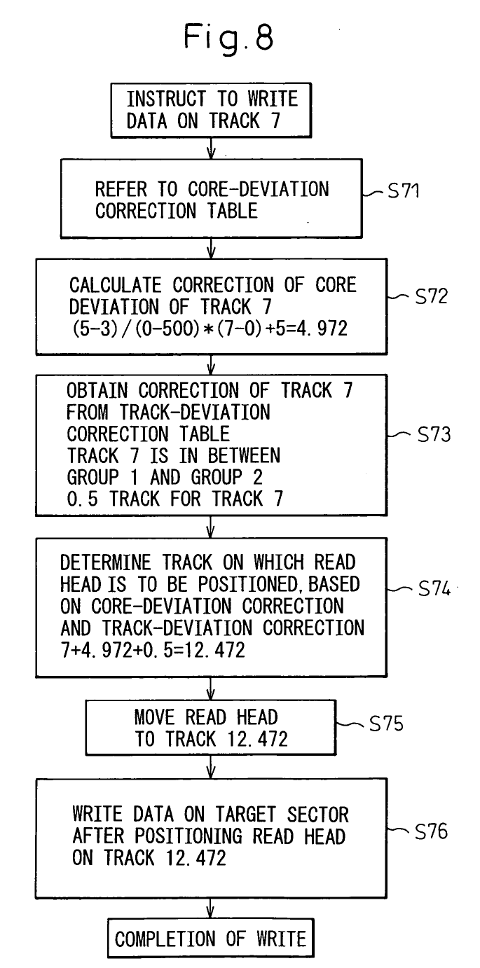

FIG. 8 shows an operation flow for data writing into track 7. When an instruction to write data on track 7 is given, the core-deviation correction table (FIG. 4A) is first referred to obtain the correction of core deviation of track 4 (step S71). Track 7 is not registered in the core-deviation correction table. Therefore, the correction of core deviation is obtained by a linear interpolation (step S72).

In other words, track 7 is positioned between track 0 and track 500. The correction of core deviation of track 0 is five tracks, and the correction of core deviation of track 500 is three tracks. Therefore, the correction of core deviation of track 7 is obtained as follows.
[(5−3)/(0−500)]×(7−0)+5=4.972

Next, the correction of track deviation of track 7 is read from the track-deviation correction table (FIG. 4B) (step S73). The correction of track deviation of track 7 is the deviation 0.5 track of the group 1, because track 7 is in between the group 1 and the group 2 and is affected by the deviation of the group 1.

After the correction of core deviation and the correction of track deviation of track 7 on which the write head is to be positioned are obtained, a track on which the read head is to be positioned is determined based on the correction of core deviation and the correction of track deviation obtained above (step S74). Specifically, a track 12.472, which is given as a sum of track 7, the correction of core deviation 4.972, and the correction of track deviation 0.5, gives a position of the track on which the read head is to be positioned.

After the track on which the read head is to be positioned is determined, the read head is moved to track 12.472 on which the read head is to be positioned (step S75). After the read head is positioned on track 12.472, data is written on a sector of track 7 as a target sector (step S76). In this way, the data can be accurately written on track 7. It is noted that track 7 is track 7.5 on the medium, As is seen from the data read operation in track 7.

### EXAMPLE 4

### Data Reading From Track 7

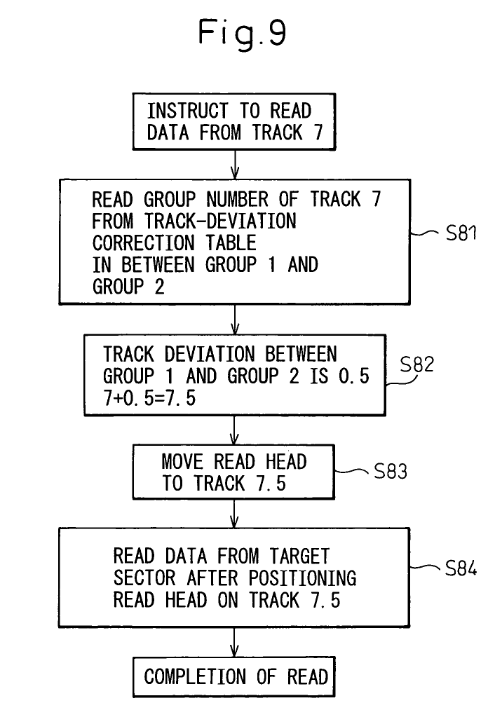

FIG. 9 shows an operation flow for reading data from track 7. Unlike the data write operation, the data read operation does not require correction of core deviation. Therefore, when a data read instruction is given, the track-deviation correction table (FIG. 4B) is referred. Then a group number corresponding to track 7 is read from the track-deviation correction table (step S81). Track 7 is in between the group 1 and the group 2.

Next, correction of track deviation is calculated, and a track on which the read head is to be positioned is calculated. In this case, track 7 is in between the group 1 and the group 2 and is affected by the track deviation of the group 1. Therefore, the correction of track deviation is 0.5. Thus, a track on which the read head is to be positioned is a track 7.5, i.e., 7+0.5=7.5. (step S82).

Consequently, the read head is moved to track 7.5 (step S83), and data is read from a sector of track 7.5 after the read head is positioned on track 7.5 (step S84). Thus, the data is read from track 7.

### EXAMPLE 5

### Data Writing Into Track 600

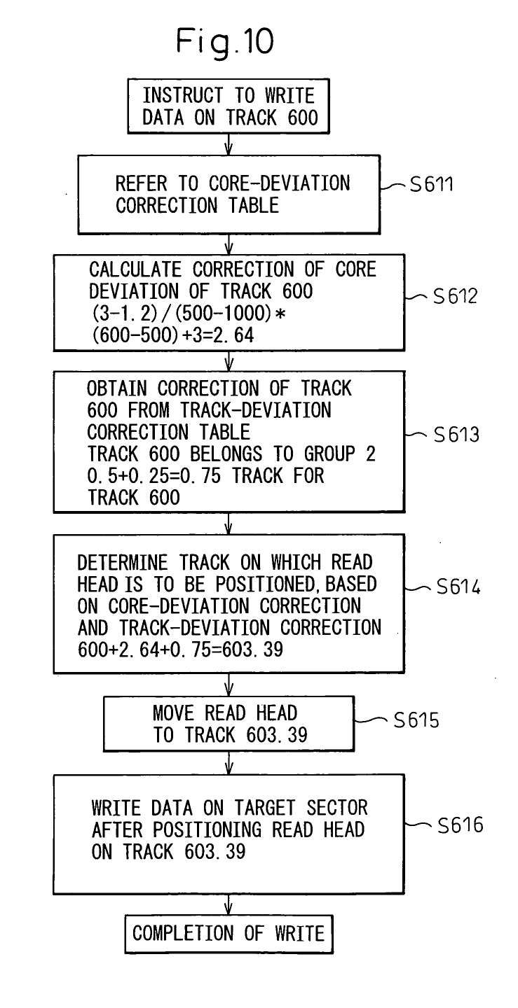

FIG. 10 shows an operation flow of data writing into track 600. When an instruction to write data on track 600 is given, the core-deviation correction table (FIG. 4A) is first referred to obtain the correction of core-deviation of track 600 (step 611). Track 600 is not registered in the core-deviation correction table. Therefore, the correction of core deviation is obtained by a linear interpolation (step S612).

In other words, track 600 is positioned between track 500 and a track 1,000. The correction of core deviation of track 500 is three tracks, and the correction of core deviation of track 1,000 is 1.2 tracks. Therefore, the correction of core deviation of track 600 is obtained as follows.
[(3−1.2)/(500−1,000)]×(600−500)+3=2.64

Next, the correction of track deviation of track 600 is read from the track-deviation correction table (FIG. 4B) (step S613). In this case, track 600 belongs to the group 2. Therefore, the correction of track deviation of track 600 is the deviation 0.75 track, which is a sum of the deviation of the group 1 and the deviation of the group 2, i.e., 0.5+0.25=0.75.

After the correction of core deviation and the correction of track deviation of track 600 on which the write head is to be positioned are obtained, a track on which the read head is to be positioned is determined based on the correction of core deviation and the correction of track deviation obtained above (step S614). Specifically, a track 603.39, which is given as a sum of track 600, the correction of core deviation 2.64, and the correction of track deviation 0.75, gives a position of the track on which the read head is to be positioned.

After the track on which the read head is to be positioned is determined, the read head is moved to track 603.39 on which the read head is to be positioned (step S615). After the read head is positioned on track 603.39, data is written on a sector of track 600 as a target sector (step S616). In this way, the data can be accurately written into track 600. It should be noted that track 600 becomes track 600.5 on the medium, as is seen from the data read operation in track 600.

### EXAMPLE 6

### Data Reading From Track 600

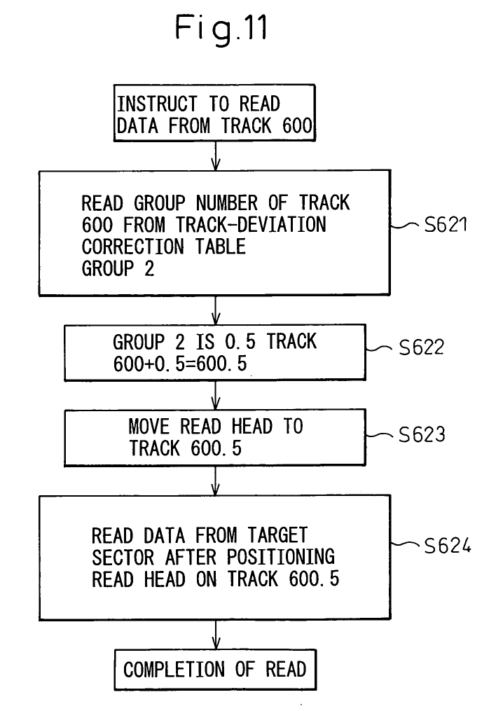

FIG. 11 shows an operation flow for reading data from track 600. When a data read instruction is given, the track-deviation correction table (FIG. 4B) is referred to. Then a group number corresponding to track 600 is read from the track-deviation correction table (step S621). Track 600 belongs to the group 2.

Next, correction of track deviation is calculated, and a track on which the read head is to be positioned is calculated. As track 600 belongs to the group 2, there is an influence of only the track deviation of the group 1, and the correction of track deviation is 0.5. Therefore, a track on which the read head is to be positioned is track 600.5, i.e., 0.5+600.5=600.5. (step S622).

Consequently, the read head is moved to track 600.5 (step S623), and data is read from a sector of track 600.5 after the read head is positioned on track 600.5 (step S624). Thus, the data is read from track 600.

### EXAMPLE 7

### Data Writing Into Track 700

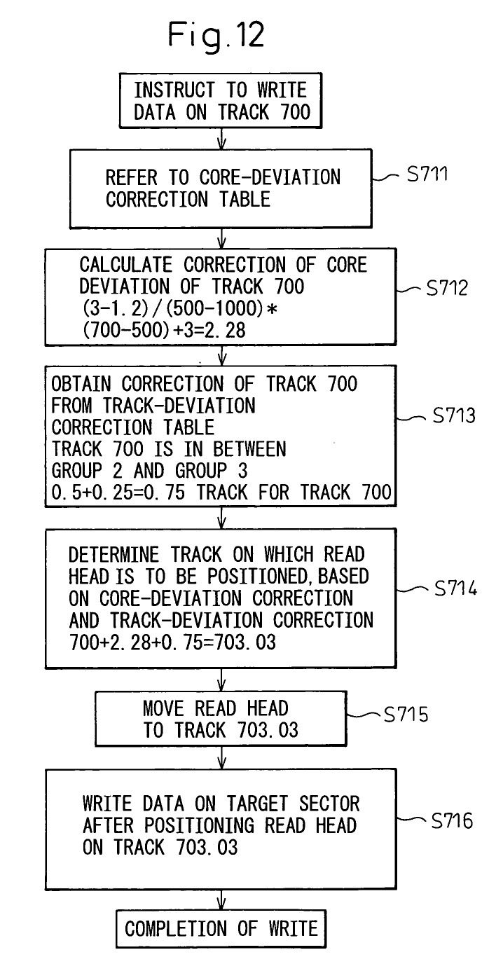

FIG. 12 shows an operation flow for data writing into track 700. When an instruction to write data on track 700 is given, the core-deviation correction table (FIG. 4A) is first referred to obtain the correction of core deviation of track 700 (step S711). Track 700 is not registered in the core-deviation correction table. Therefore, the correction of core deviation is obtained by a linear interpolation (step S712).

Track 700 is positioned between track 500 and a track 1,000. The correction of core deviation of track 500 is three tracks, and the correction of core deviation of track 1,000 is 1.2 tracks. Therefore, the correction of core deviation of track 700 is obtained as follows.
[(3−1.2)/(500−1,000)]×(700−500)+3=2.28

Next, the correction of track deviation of track 700 is obtained from the track-deviation correction table (FIG. 4B) (step S713). Because track 700 is in between the group 2 and the group 3, a sum of the deviation of the group 1 and the deviation of the group 2, i.e., 0.5+0.25=0.75 track, provides the correction of track deviation of track 700.

After the correction of core deviation and the correction of track deviation of track 700 on which the write head is to be positioned are obtained, a track on which the read head is to be positioned is determined based on the correction of core deviation and the correction of track deviation obtained above (step S714). Specifically, a track 703.03, which is given as a sum of track 700, the correction of core deviation 2.28, and the correction of track deviation 0.75, gives a position of the track on which the read head is to be positioned.

After the track on which the read head is to be positioned is determined, the read head is moved to track 703.03 on which the read head is to be positioned (step S715). After the read head is positioned on track 703.0.3, data is written into a sector of track 700 as a target sector (step S716). Thus, the data can be accurately written into track 700. It is to be noted that track 700 is track 700.75 on the medium, as is seen from the data read operation in track 700.

### EXAMPLE 8

### Data Reading From Track 700

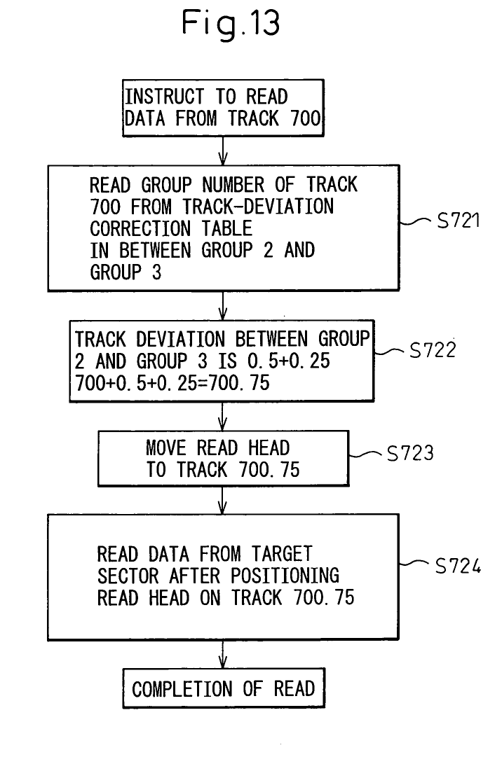

FIG. 13 shows an operation flow for reading data from track 700. When a data read instruction is given, the track-deviation correction table (FIG. 4B) is referred to. Then a group number corresponding to track 700 is read from the track-deviation correction table (step S721). Track 700 is in between the group 2 and the group 3.

Next, correction of track deviation is calculated, and a track on which the read head is to be positioned is calculated. Track 700 is in between the group 2 and the group 3, and is affected by the track deviation of the group 1 and the group 2. The correction of track deviation is 0.5+0.25=0.75. Therefore, the track on which the read head is to be positioned is track 700.75, i.e., 700+0.75=700.75. (step S722).

Consequently, the read head moves to track 700.75 (step S723), and data is read from a sector of track 700.75 after the read head is positioned on track 700.75 (step S724). Thus, the data is read from track 700.

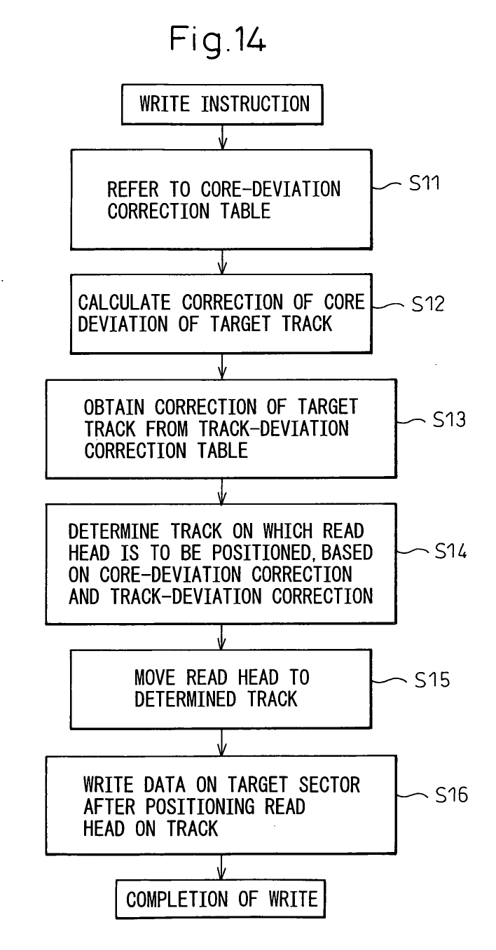

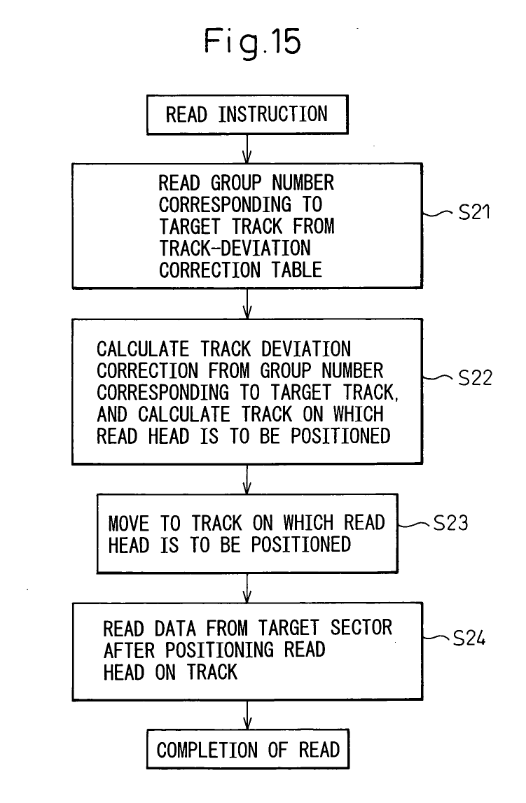

The write operation flows and the read operation flows explained above are summarized in FIG. 14 and FIG. 15.

According to the write operation flow shown in FIG. 14, when an instruction to write data on a target track is given, the core-deviation correction table is first referred to obtain the correction of core deviation of the target track (step S11). When the target track is not registered in the core-deviation correction table, the correction of core deviation is obtained by linear interpolation (step S12). The core-deviation correction table and the track-deviation correction table can be stored in a nonvolatile memory like a flash memory or a system region of a hard disc.

Next, correction of track deviation of the target track is read from the track-deviation correction table (step S13). If a target track is in a certain group n, a sum of deviations of groups m (m≦n), i.e., a group 1 to the group n, is set as track deviation correction of the target track. For example, if a target track is track 600 as shown in FIG. 4B, the correction of track deviation is 0.5+0.25. If a target track is in between a group (n−1) and a group n, a sum of deviations of the group 1 to the group (n−1) provides the correction of track deviation of the target track. For example, if a target track is track 700 as shown in FIG. 4B, the correction of track deviation is 0.5+0.25.

After the correction of core deviation and the correction of track deviation of the target track on which data is to be written is obtained, a track on which the read head is to be positioned is determined based on the correction of core deviation and the correction of track deviation that are obtained (step S14). Specifically, a sum of the target track, the correction of core deviation, and the track deviation correction provides a track on which the read head is to be positioned.

After the track on which the read head is to be positioned is determined, the read head is moved to this track (step S15). After the read head is positioned on this track, data is written into a sector of the target track (step S16), thereby completing the data write.

The data read operation in the read operation flow shown in FIG. 15 does not require correction of core deviation, unlike the write operation. Therefore, when a data read instruction is given, first, a group number or group numbers corresponding to a target track from which data is to be read is obtained from the track-deviation correction table (step S21). If there is a group to which the target track belongs, the number of this group is given as the group number. When there is no group to which the target track belongs, the numbers of the groups that sandwich the target track are given as the group numbers.

Next, correction of track deviation is calculated from the group number or group numbers corresponding to the target track, and a track on which the read head is to be positioned is calculated (step S22). When the target track belongs to a group n, a sum of corrections of track deviation up to the group (n−1) provides correction of track deviation. For example, in reading data from track 600, track 600 (FIG. 4B) belongs to the group 2. Therefore, 0.5 track as the correction of track deviation of the group 1 provides the correction of track deviation. In reading data from track 4 (FIG. 4B), track 4 belongs to group 1. Correction of track deviation becomes zero, because group 0 is not present. When there is no group to which a target track belongs, and if the target track is in between a group (n−1) and a group n, a sum of corrections of track deviation up to the group (n−1) provides the correction of track deviation. For example, at the time of reading data from track 700 (FIG. 4B), the correction of track deviation becomes 0.5+0.25.

After the correction of track deviation is obtained, the read head is moved to a target track (step S23). After the read head is positioned on the target track, data is read from a sector of the target track (step S24), thereby completing the read operation.

The track-deviation correction table stores data obtained by carrying out a test after writing servo data, and the data can be stored in a suitable storage device, as described above. As a storage device, there is a memory 28 like a rewritable nonvolatile flash memory (FIG. 1), or a system area of a medium or a disk. A position at which the memory is disposed is not particularly limited, and the memory can be disposed on the printed circuit board 20 or on the disc enclosure 10.

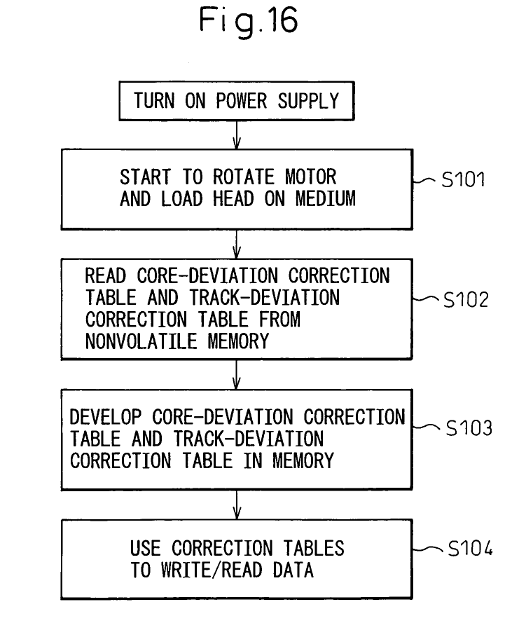

If the storage device has a rewritable nonvolatile memory, in a test after the manufacturing, the core-deviation correction table and the track-deviation correction table, including a deviation intrinsic to a machine type, are stored in the nonvolatile memory. FIG. 16 shows a flow of a start operation of a magnetic disc device in this case. When a power supply to the magnetic disc device is turned on, a start process is started to rotate the motor, and the head is loaded on a medium (step S101). Then, the core-deviation correction table and the track-deviation correction table stored in the nonvolatile memory are read (step S102), and the core-deviation correction table and the track-deviation correction table are developed in the main memory (step S103). The core-deviation correction table and the track-deviation correction table are used to write data and read data thereafter (step S104).

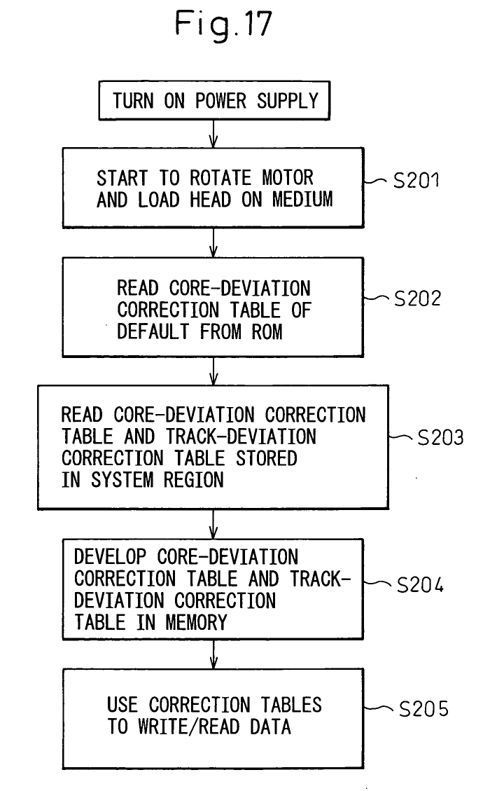

FIG. 17 shows a flow of a start operation of the magnetic recording device having a correction table in the system region of the medium. When the power supply to the magnetic disc device is turned on, a start process is started to rotate the motor, and the head is loaded on a medium (step S201). Then, the core-deviation correction table of default is read from a ROM within the device (step S202). The core-deviation correction table and the track-deviation correction table stored in the system region of the medium are read (step S203). The core-deviation correction table that is stored in the ROM stores correction of core deviation that is generally used. The core-deviation correction table that is stored in the system region of the medium stores correction of core deviation intrinsic to the machine type.

Next, the core-deviation correction table and the track-deviation correction table are all developed in the main memory (step S204). The core-deviation correction table and the track-deviation correction table are used to write data and read data thereafter (step S205).

What is claimed is:

1. A magnetic storage device comprising:
a magnetic storage medium on which a servo track is formed;
a head having a read head and a write head;
a head moving unit that moves the head; and
a storage unit that stores information of track deviation due to an abnormal pitch of the servo track, wherein
a position of the head is corrected based on track deviation information that is read out from the storage unit.

2. The magnetic storage device according to claim 1, wherein
the storage unit is a nonvolatile memory or a system region of the magnetic storage medium.

3. The magnetic storage device according to claim 1, wherein
the track deviation information is stored in a table in which a track address, track deviation, and a group number of a group of continuous track deviation are related to each other.

4. The magnetic storage device according to any one of claim 1, wherein
the correction of the head position includes correction of core deviation information based on the track deviation information.

5. A method of correcting a magnetic head position, comprising:
storing information of track deviation due to an abnormal track pitch; and
correcting a position of a read head that should be positioned on a track using the stored track deviation information.
